(19) United States
(12) Patent Application Publication
(10) Pub. No.: US 2024/0152923 A1
(43) Pub. Date: May 9, 2024

(54) DATA MANAGEMENT USING SCORE CALIBRATION AND SCALING FUNCTIONS

(71) Applicant: Stripe, Inc., South San Francisco, CA (US)

(72) Inventor: Emmanuel Ameisen, San Francisco, CA (US)

(21) Appl. No.: 17/979,985

(22) Filed: Nov. 3, 2022

(51) Int. Cl. G06Q 20/40

(52) U.S. Cl. CPC G06Q 20/4016

(57) ABSTRACT

Various embodiments described herein support or provide for data management operations, such as identifying an uncalibrated fraud score that corresponds to a set of transactions; using a machine learning model to generate a calibrated fraud score based on the uncalibrated fraud score; determining a calibrated fraud score distribution associated with the calibrated fraud score; identifying an uncalibrated fraud score distribution associated with the uncalibrated fraud score; using a score scaling function to generate a mapping between the calibrated fraud score distribution and the uncalibrated fraud score distribution; and generating a scaled calibrated fraud score based on the mapping.

### TECHNICAL FIELD

The present disclosure generally relates to data management, and, more particularly, various embodiments described herein provide for systems, methods, techniques, instruction sequences, and devices that facilitate score calibration and score scaling using machine learning technologies.

### BACKGROUND

Scores, before calibration, may carry limited interpretable meaning. In particular, an uncalibrated score may be interpreted based on other scores generated by the same machine learning (ML) model. However, it may not carry any interpretable meaning in view of scores that are generated by ML models of different versions and/or types. Further, an uncalibrated score may not indicate a specific probability of occurrence of certain events (e.g., probability of fraud). Last but not least, score calibration can cause a significant distribution shift since the calibrated scores tend to be lower than the uncalibrated ones. Unexpected distribution shifts can cause various issues for users who routinely consume the scores for downstream analysis.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some embodiments are illustrated by way of examples, and not limitations, in the accompanying figures.

FIG. 1 is a block diagram showing an example data system that includes a data management system, according to various embodiments of the present disclosure.

FIG. 2 is a block diagram illustrating an example data management system, according to various embodiments of the present disclosure.

FIG. 3 is a flowchart illustrating an example method for generating and scaling calibrated scores, according to various embodiments of the present disclosure.

FIG. 4 is a flowchart illustrating an example method for generating and scaling calibrated scores, according to various embodiments of the present disclosure.

FIG. 5 is a block diagram illustrating an example chart generated based on an example positive sum of sigmoid function that is used by a data management system for score calibration, according to various embodiments of the present disclosure.

FIG. 6 is a block diagram illustrating an example model architecture generated by a data management system, according to various embodiments of the present disclosure.

FIG. 7 is a block diagram illustrating an example chart generated by a data management system, according to various embodiments of the present disclosure.

FIG. 8 is a block diagram illustrating example graphs generated by a data management system before a score scaling function is used, according to various embodiments of the present disclosure.

FIG. 9 is a block diagram illustrating example graphs generated by a data management system after a score scaling function is used, according to various embodiments of the present disclosure.

FIG. 10 is a block diagram illustrating a representative software architecture, which may be used in conjunction with various hardware architectures herein described, according to various embodiments of the present disclosure.

FIG. 11 is a block diagram illustrating components of a machine able to read instructions from a machine storage medium and perform any one or more of the methodologies discussed herein according to various embodiments of the present disclosure.

### DETAILED DESCRIPTION

The description that follows includes systems, methods, techniques, instruction sequences, and computing machine program products that embody illustrative embodiments of the present disclosure. In the following description, for purposes of explanation, numerous specific details are set forth in order to provide a thorough understanding of embodiments. It will be evident, however, to one skilled in the art that the present inventive subject matter may be practiced without these specific details.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various embodiments may be given throughout this description. These are merely descriptions of specific embodiments. The scope or meaning of the claims is not limited to the embodiments given.

Uncalibrated scores usually do not indicate specific probabilities of certain events (e.g., fraudulent transactions). For example, an uncalibrated score (also referred to as uncalibrated fraud scores or raw scores) of 0.2 does not translate into a 20% probability of fraudulent transactions. Further, different models (e.g., machine learning models) that generate uncalibrated scores (e.g., uncalibrated raw scores) may have different score distributions. Therefore, every time a new model is released, the analysis based on scores generated by previously-released models can be rendered obsolete. Last but not least, calibration can cause a significant distribution shift since the calibrated scores tend to be lower than the uncalibrated ones. Unexpected distribution shifts can cause various issues for users who routinely consume such scores for downstream analysis.

Various examples include systems, methods, and non-transitory computer-readable media for managing data, particularly facilitating score calibration and scaling using machine learning technologies. Various embodiments described herein can use state-of-the-art machine-learning (ML) and artificial intelligence (AI) to analyze and process a large volume of data created daily to effectively calibrate and scale scores and generate mappings between scores and score distributions, as described herein.

The uncalibrated fraud score (e.g., uncalibrated raw score) does not indicate a specific probability of fraud. Instead, in various embodiments, it can only indicate a likelihood that the set of transactions includes at least one fraudulent transaction. In various embodiments, a data management system uses one or more machine learning models to generate a plurality of uncalibrated fraud scores (e.g., uncalibrated raw scores) for multiple sets of transactions. A higher score indicates a greater likelihood that a corresponding set of transactions includes fraudulent transactions. For example, suppose uncalibrated score A is higher than uncalibrated score B, in that case, the set of transactions of uncalibrated score A is more likely to include fraudulent transactions than the set of transactions of uncalibrated score B. Alternatively, in various embodiments, the uncalibrated score A having a higher score value may indicate that the set of transactions of uncalibrated score A is more likely to include a larger amount of fraudulent transactions than the set of transactions of uncalibrated score B.

In various embodiments, the data management system uses a score scaling function to map a scaled score (e.g., uncalibrated scaled score) of a value (e.g., 75) to an uncalibrated raw score such that a desirable rate of transactions (e.g., payment transactions) can be caused to be blocked. The uncalibrated scaled score can be adjusted based on an adjusted desirable rate of payment transactions.

In various embodiments, the data management system generates a calibrated score (also referred to as calibrated fraud score) based on the uncalibrated fraud score. A calibrated fraud score can indicate an amount of the set of transactions that are fraudulent. For example, the calibrated fraud score of 0.2 indicates that 20% of the set of transactions are fraudulent transactions.

In various embodiments, a calibrated raw score is generated by the one or more calibration machine learning models. The data management system can use a score scaling function to generate calibrated scaled score based on the calibrated raw score so that a score distribution of the calibrated scaled score is identical or similar to a score distribution of the uncalibrated scaled score described herein.

In various embodiments, the data management system determines a calibrated score distribution (also referred to as calibrated fraud score distribution) associated with the calibrated fraud score. A calibrated fraud score distribution can include a plurality of calibrated fraud scores. Each calibrated fraud score corresponds to an amount of a corresponding set of transactions that are fraudulent.

In various embodiments, the data management system identifies (or determines) an uncalibrated fraud score distribution associated with the uncalibrated fraud score. An uncalibrated fraud score distribution can include a plurality of uncalibrated fraud scores. Each calibrated fraud score can represent an amount of likely fraudulent transactions from the set of transactions based on which the calibrated fraud score is generated. Each set of transactions can correspond to an amount of grouped transactions within a percentile (e.g., between 0.1 and 0.2 in the range of 0 to 1) in the score distribution.

In various embodiments, the data management system generates one or more machine learning models (also referred to as calibration machine learning models or calibration models) configured (or built) based on a positive sum of sigmoids algorithm. The data management system may use the one or more calibration models to calibrate scores based on training data. In various embodiments, training data can include previously generated calibrated fraud scores based on other uncalibrated fraud scores associated with other sets of transactions. The configurations of the one or more machine learning models may be adjusted (e.g., manually or automatically) based on outputs to improve the performance of the models over time.

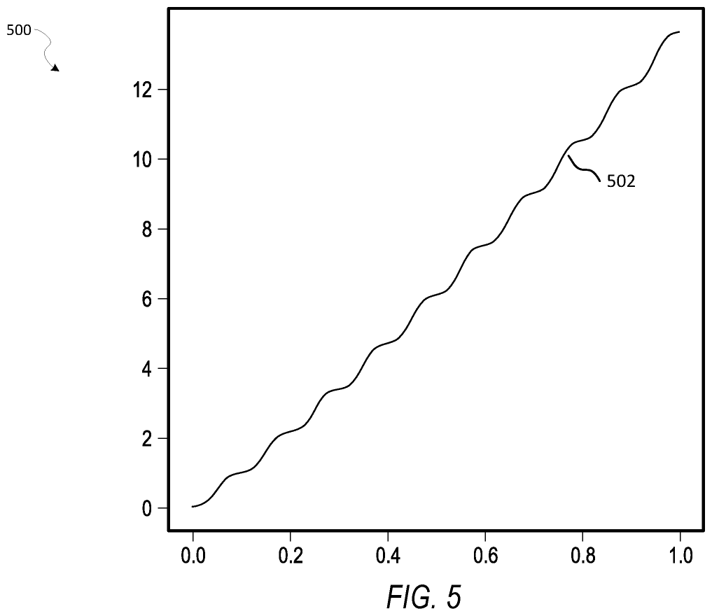

In various embodiments, the positive sum of sigmoids algorithm defines a plurality of sigmoid functions, as illustrated in FIG. 5. The data management system may use the positive sum of sigmoids algorithm to learn a calibration function that maps the uncalibrated fraud score to the calibrated fraud scores.

In various embodiments, the data management system may determine (or learn) one or more weights based on the use of the one or more machine learning models (e.g., calibration models). The data management system may determine a percentage of the amount of fraudulent transactions based on a number of the set of transactions and evaluate a correspondence between the calibrated fraud score and the percentage of the amount of the set of transactions. For example, if the calibrated fraud score is 0.2 and the percentage of the amount of fraudulent transactions is 20%, the score is perfectly calibrated.

In various embodiments, the data management system can update the one or more weights to improve the correspondence in situations when the score is not perfectly calibrated. Further calibrated fraud scores can be generated based on the one or more updated weights.

In various embodiments, the data management system uses a score scaling function to generate a mapping between the calibrated fraud score distribution and the uncalibrated fraud score distribution. Based on the mapping, the data management system generates one or more scaled calibrated fraud scores (also referred to as calibrated scaled scores). A scaled calibrated fraud score corresponds to a percentile in the uncalibrated fraud score distribution. Under this approach, the mapping allows the calibrated fraud score distribution to overlap completely or partially (closely) with the uncalibrated fraud score distribution, thereby minimizing the score distribution shift caused by the calibration.

In various embodiments, mappings may be generated between various score and score distributions. For example, the data management system can generate mappings between pre-scaling calibrated fraud score distributions (also referred to as calibrated fraud score distributions) and post-scaling calibrated fraud score distributions. Such mappings may also be updated based on the one or more parameters (or variables) included in one or more requests.

In various embodiments, the data management system can cause the display of the mapping, the scaled calibrated fraud score, and the scaled calibrated fraud score distribution on a user interface of a device.

In various embodiments, the data management system may receive a request from an entity (e.g., a merchant) to adjust a score distribution, such as the calibrated fraud score distribution. The request may include one or more parameters associated with an adjusted score distribution. The data management system may use one or more score scaling functions to generate an updated mapping based on the one or more parameters and cause the display of the updated mapping and the adjusted score distribution on the user interface of the device.

In various embodiments, the data management system uses a calibration function to generate calibrated raw scores based on uncalibrated raw scores. The data management system uses a score scaling function to generate calibrated scaled scores based on calibrated raw scores and uncalibrated scaled scores such that the resulting score distribution of the calibrated scaled scores looks identical or similar to the score distribution of the uncalibrated scaled scores. In various embodiments, the scaling function that is used to generate uncalibrated scaled scores may be different from a scaling function that is used to generate calibrated scaled scores.

As used herein, a machine learning (ML) model can comprise any predictive model that is generated based on (or that is trained on) training data. Once generated/trained, a machine learning model can receive one or more inputs (e.g., one or more tags), extract one or more features, and generate an output for the inputs based on the model's training. Different types of machine learning models can include, without limitation, ones trained using supervised learning, unsupervised learning, reinforcement learning, or deep learning (e.g., complex neural networks).

Reference will now be made in detail to embodiments of the present disclosure, examples of which are illustrated in the appended drawings. The present disclosure may, however, be embodied in many different forms and should not be construed as being limited to the embodiments set forth herein.

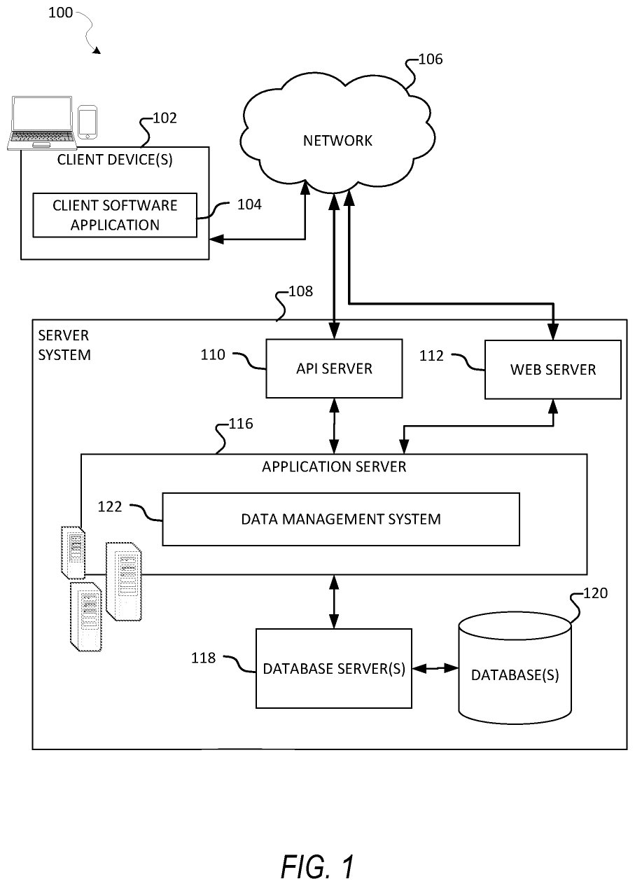

FIG. 1 is a block diagram showing an example data system 100 that includes a data management system (hereafter, the data management system 122, or system 122), according to various embodiments of the present disclosure. By including the data management system 122, the data system 100 can facilitate generating and scaling calibrated scores using machine learning technologies. As shown, the data system 100 includes one or more client devices 102, a server system 108, and a network 106 (e.g., including Internet, wide-area-network (WAN), local-area-network (LAN), wireless network, etc.) that communicatively couples them together. Each client device 102 can host a number of applications, including a client software application 104. The client software application 104 can communicate data with the server system 108 via a network 106. Accordingly, the client software application 104 can communicate and exchange data with the server system 108 via network 106.

The server system 108 provides server-side functionality via the network 106 to the client software application 104. While certain functions of the data system 100 are described herein as being performed by the data management system 122 on the server system 108, it will be appreciated that the location of certain functionality within the server system 108 is a design choice. For example, it may be technically preferable to initially deploy certain technology and functionality within the server system 108, but to later migrate this technology and functionality to the client software application 104.

The server system 108 supports various services and operations that are provided to the client software application 104 by the data management system 122. Such operations include transmitting data from the data management system 122 to the client software application 104, receiving data from the client software application 104 to the system 122, and the system 122 processing data generated by the client software application 104. Data exchanges within the data system 100 may be invoked and controlled through operations of software component environments available via one or more endpoints, or functions available via one or more user interfaces of the client software application 104, which may include web-based user interfaces provided by the server system 108 for presentation at the client device 102.

With respect to the server system 108, each of an Application Program Interface (API) server 110 and a web server 112 is coupled to an application server 116, which hosts the data management system 122. The application server 116 is communicatively coupled to a database server 118, which facilitates access to a database 120 that stores data associated with the application server 116, including data that may be generated or used by the data management system 122.

The API server 110 receives and transmits data (e.g., API calls, commands, requests, responses, and authentication data) between the client device 102 and the application server 116. Specifically, the API server 110 provides a set of interfaces (e.g., routines and protocols) that can be called or queried by the client software application 104 in order to invoke the functionality of the application server 116. The API server 110 exposes various functions supported by the application server 116 including, without limitation: user registration; login functionality; data object operations (e.g., generating, storing, retrieving, encrypting, decrypting, transferring, access rights, licensing, etc.); and user communications.

Through one or more web-based interfaces (e.g., web-based user interfaces), the web server 112 can support various functionality of the data management system 122 of the application server 116 including, without limitation: generating calibrated fraud scores; scaling calibrated fraud scores; and generating mappings between calibrated fraud scores and uncalibrated fraud scores.

The application server 116 hosts a number of applications and subsystems, including the data management system 122, which supports various functions and services with respect to various embodiments described herein.

The application server 116 is communicatively coupled to a database server 118, which facilitates access to database(s) 120 in which data associated with the data management system 122 may be stored.

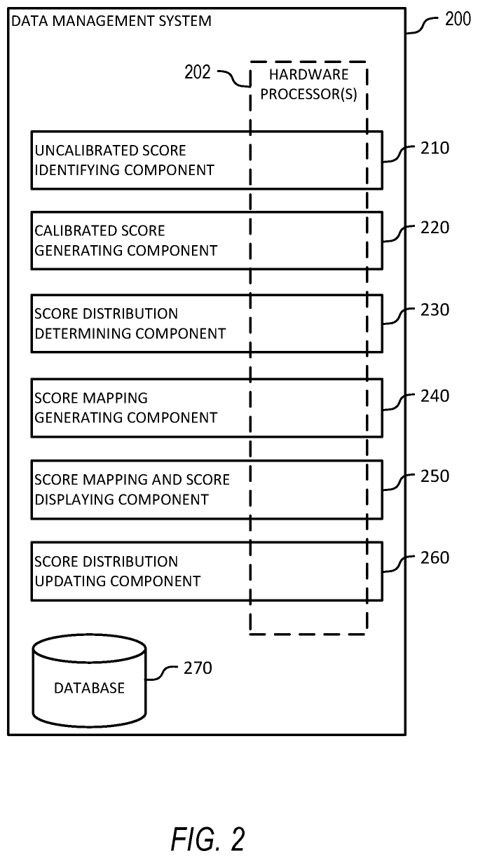

FIG. 2 is a block diagram illustrating an example data management system 200, according to various embodiments of the present disclosure. For some embodiments, the data management system 200 represents an example of the data management system 122 described with respect to FIG. 1. As shown, the data management system 200 comprises an uncalibrated score identifying component 210, a calibrated score generating component 220, a score distribution determining component 230, a score mapping generating component 240, a score mapping and score displaying component 250, a score distribution updating component 260, and a database 270. According to various embodiments, one or more of the uncalibrated score identifying component 210, the calibrated score generating component 220, the score distribution determining component 230, the score mapping generating component 240, the score mapping and score displaying component 250, and the score distribution updating component 260 are implemented by one or more hardware processors 202. Data generated by one or more of the uncalibrated score identifying component 210, the calibrated score generating component 220, the score distribution determining component 230, the score mapping generating component 240, the score mapping and score displaying component 250, and the score distribution updating component 260 may be stored in a database (or datastore) 270 of the data management system 200.

The uncalibrated score identifying component 210 is configured to identify uncalibrated scores. Uncalibrated scores, as described herein, can be generated by the data management system using one or more machine learning models to predict fraudulent transactions. Uncalibrated fraud scores usually have limited interpretable meaning and do not indicate a specific probability of fraud. Instead, in various embodiments, they can only indicate a likelihood that the set of transactions includes at least one fraudulent transaction.

The calibrated score generating component 220 is configured to use one or more machine learning models to generate calibrated fraud scores based on uncalibrated fraud scores. In particular, the one or more machine learning models can be configured (or built) based on a positive sum of sigmoids algorithm. A calibration function can be learned via using the one or more machine learning models. The calibration function maps the uncalibrated fraud score to the calibrated fraud scores.

In various embodiments, one or more weights can be learned (or determined) based on the use of the one or more machine learning models. The one or more weights can be evaluated and updated to improve the correspondence between calibrated scores and uncalibrated scores, thereby improving model performance.

The score distribution determining component 230 is configured to determine uncalibrated fraud score distributions based on uncalibrated fraud scores and determine calibrated fraud score distributions based on calibrated fraud scores.

The score mapping generating component 240 is configured to use one or more score scaling functions to generate one or more mappings between calibrated fraud score distributions and uncalibrated fraud score distributions.

The score displaying component 250 is configured to cause data, including without limitation, mappings, uncalibrated fraud scores, uncalibrated fraud score distributions, calibrated fraud scores, scaled calibrated fraud scores, and/or post-scaling calibrated fraud score distributions to be displayed on a user interface of a device.

The score distribution updating component 260 is configured to use one or more score scaling functions to generate updated mappings based on requests, as described herein

In various embodiments, each of the uncalibrated score identifying component 210, the calibrated score generating component 220, the score distribution determining component 230, the score mapping generating component 240, the score mapping and score displaying component 250 can comprise a machine learning (ML) model that enables or facilitates operation as described herein.

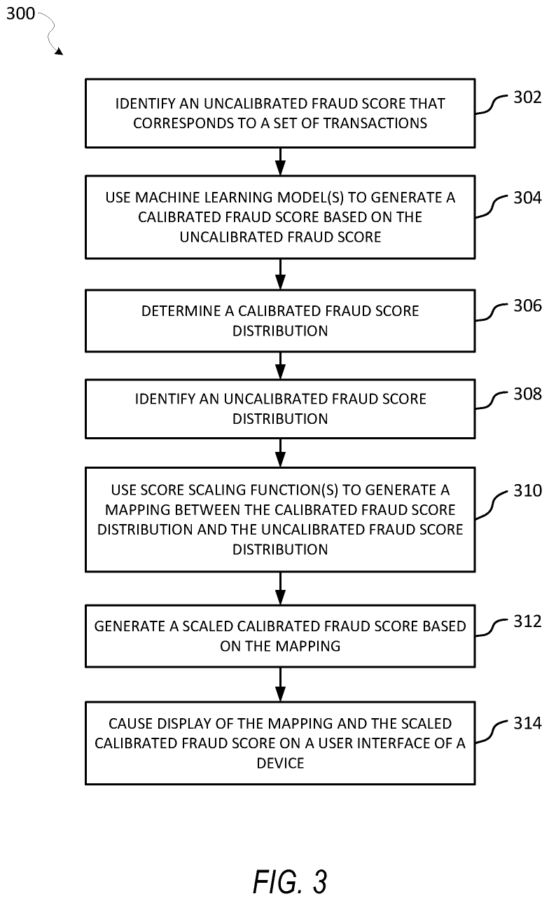

FIG. 3 is a flowchart illustrating an example method 300 for generating and scaling calibrated scores, according to various embodiments of the present disclosure. It will be understood that example methods described herein may be performed by a machine in accordance with some embodiments. For example, method 400 can be performed by the data management system 122 described with respect to FIG. 1, the data management system 200 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 300 may be represented by executable instructions that, when executed by a processor of a computing device, cause the computing device to perform method 300. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel.

At operation 302, a processor identifies uncalibrated scores. Uncalibrated scores, as described herein, can be generated by one or more machine learning models to predict fraudulent transactions. Uncalibrated fraud scores usually have limited interpretable meaning and do not indicate a specific probability of fraud. Instead, in various embodiments, they can only indicate a likelihood that the set of transactions includes at least one fraudulent transaction.

At operation 304, a processor uses one or more machine learning models to generate calibrated fraud scores based on uncalibrated fraud scores. In particular, the one or more machine learning models can be configured (or built) based on a positive sum of sigmoids algorithm. A calibration function and the associated weights can be learned via using the one or more machine learning models. Weights can be evaluated and updated to improve the correspondence between calibrated scores and uncalibrated scores, thereby improving model performance.

At operation 306, a processor determines uncalibrated fraud score distributions based on uncalibrated fraud scores.

At operation 308, a processor determines (or identifies) calibrated fraud score distributions based on calibrated fraud scores.

At operation 310, a processor uses one or more score scaling functions to generate scaled calibrated fraud score distributions and one or more mappings between calibrated fraud score distributions and uncalibrated fraud score distributions.

At operation 312, the processor generates scaled calibrated fraud scores based on the one or more mappings. A scaled calibrated fraud score corresponds to the same (or similar) percentile of the uncalibrated fraud score that appears in the uncalibrated fraud score distribution.

In various embodiments, a post-scaling calibrated fraud score distribution may be generated based on one or more scaled calibrated fraud scores. The post-scaling calibrated fraud score distribution may overlap completely or partially (closely) with the uncalibrated fraud score distribution, thereby minimizing the score distribution shift caused by the calibration.

At operation 314, a processor causes data, including without limitation, mappings, uncalibrated fraud scores, uncalibrated fraud score distributions, calibrated fraud scores, scaled calibrated fraud scores, and/or post-scaling calibrated fraud score distributions to be displayed on a user interface of a device.

Though not illustrated, method 300 can include an operation where a graphical user interface can be displayed (or caused to be displayed) by the hardware processor. For instance, the operation can cause a client device (e.g., the client device 102 communicatively coupled to the data management system 122) to display the graphical user interface. This operation for displaying the graphical user interface can be separate from operations 302 through 314 or, alternatively, form part of one or more of operations 302 through 314.

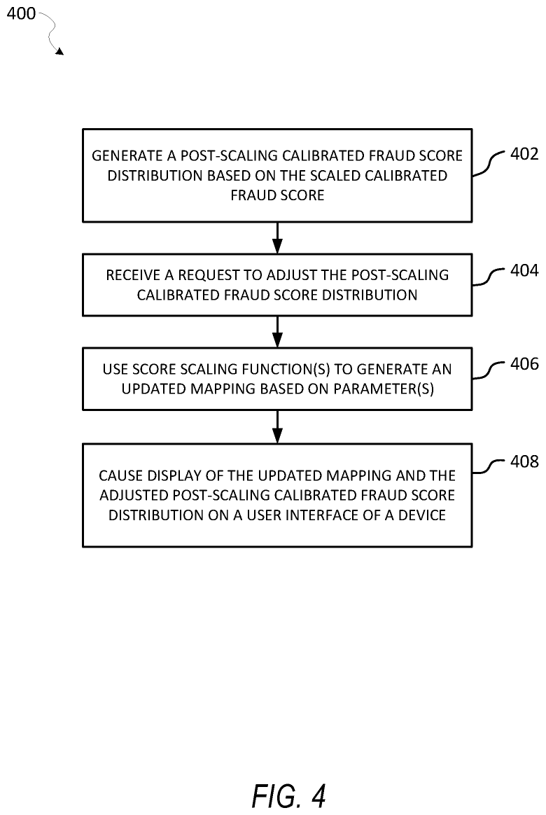

FIG. 4 is a flowchart illustrating an example method 400 for generating and scaling calibrated scores, according to various embodiments of the present disclosure. It will be understood that example methods described herein may be performed by a machine in accordance with some embodiments. For example, method 400 can be performed by the data management system 122 described with respect to FIG. 1, the data management system 200 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 400 may be represented by executable instructions that, when executed by a processor of a computing device, cause the computing device to perform method 400. Depending on the embodiment, an operation of an example method described herein may be repeated in different ways or involve intervening operations not shown. Though the operations of example methods may be depicted and described in a certain order, the order in which the operations are performed may vary among embodiments.

In various embodiments, one or more operations of method 400 may be a sub-routine of one or more of the operations of method 300. In various embodiments, one or more operations in method 400 may be performed subsequent to the operations of method 300.

At operation 402, a processor generates a post-scaling calibrated fraud score distribution based on the scaled calibrated fraud score. The post-scaling calibrated fraud score distribution may include a plurality of scaled calibrated fraud scores that are generated using the calibration and scaling functions, as described herein. The post-scaling calibrated fraud score distribution may overlap completely or partially (closely) with the uncalibrated fraud score distribution.

At operation 404, a processor receives a request to adjust the post-scaling calibrated fraud score distribution. The request may include one or more parameters associated with an adjusted post-scaling calibrated fraud score distribution.

At operation 406, a processor uses one or more score scaling functions to generate an updated mapping based on the one or more parameters. Specifically, the processor may update the post-scaling calibrated fraud score distribution based on the one or more parameters and generate the updated mapping between the uncalibrated fraud score distribution and the updated post-scaling calibrated fraud score distribution.

In various embodiments, mapping may be generated based on pre-scaling calibrated fraud score distribution (also referred to as calibrated fraud score distribution) and post-scaling calibrated fraud score distribution. Such mappings may also be updated based on the one or more parameters included in one or more requests.

In various embodiments, a mapping may be generated based on uncalibrated fraud score distribution (also referred to as calibrated fraud score distribution) and post-scaling calibrated fraud score distribution. Such mappings may also be updated based on the one or more parameters included in one or more requests.

At operation 408, a processor causes the display of the updated mapping and the adjusted post-scaling calibrated fraud score distribution on the user interface of the device.

Though not illustrated, method 400 can include an operation where a graphical user interface can be displayed (or caused to be displayed) by the hardware processor. For instance, the operation can cause a client device (e.g., the client device 102 communicatively coupled to the data management system 122) to display the graphical user interface. This operation for displaying the graphical user interface can be separate from operations 402 through 408 or, alternatively, form part of one or more of operations 402 through 408.

FIG. 5 is a block diagram illustrating an example chart 500 generated based on an example positive sum of sigmoid function that is used by a data management system for score calibration, according to various embodiments of the present disclosure. As shown, the positive sum of sigmoids algorithm defines a plurality of sigmoid functions. Line 502 is generated based on a plurality of unweighted sigmoid functions.

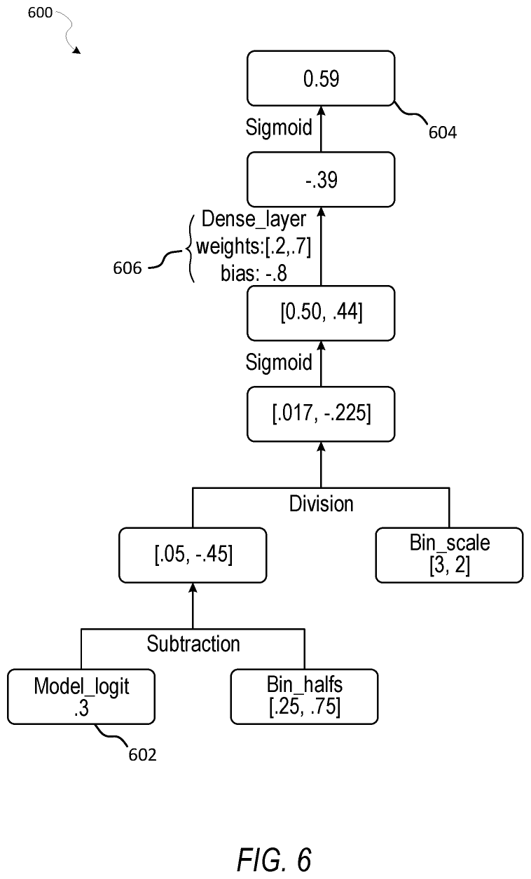

FIG. 6 is a block diagram illustrating an example model architecture 600 generated by a data management system, according to various embodiments of the present disclosure. As shown, the example model architecture 600 is designed based on an example positive sum of sigmoids algorithm where two sigmoid functions are defined. Block 602 represents an uncalibrated ML model that is associated with an output score (e.g., uncalibrated score) of 0.3. Block 604 represents a calibrated ML model that is associated with an output score (e.g., calibrated score) of 0.59. The calibrated score of 0.59 indicates that 59% of the corresponding set of transactions are fraudulent transactions.

Various parameters can be learned by using the one or more ML models that are configured based on the positive sum of sigmoids algorithm. Learnable parameters 606 include weights, dense layer, and bias, as illustrated in FIG. 6.

In various embodiments, learnable parameters 606 can be evaluated based on outputs (e.g., calibrated scores). The evaluation can be conducted based on the correspondence between the calibrated fraud score and the percentage (also referred to as probability of fraud) of the amount of the set of transactions that are fraudulent.

Learnable parameters 606 can be updated to improve the correspondence between calibrated scores and the probability of fraud, thereby improving model performance. In particular, machine learning optimization can be used to evaluate and update such learnable parameters. An example calibration function can be F(x)=w_1*S_1(x)+w_2*S_2(x). w_1 and w_2 represent the weights that can be learned, as described herein.

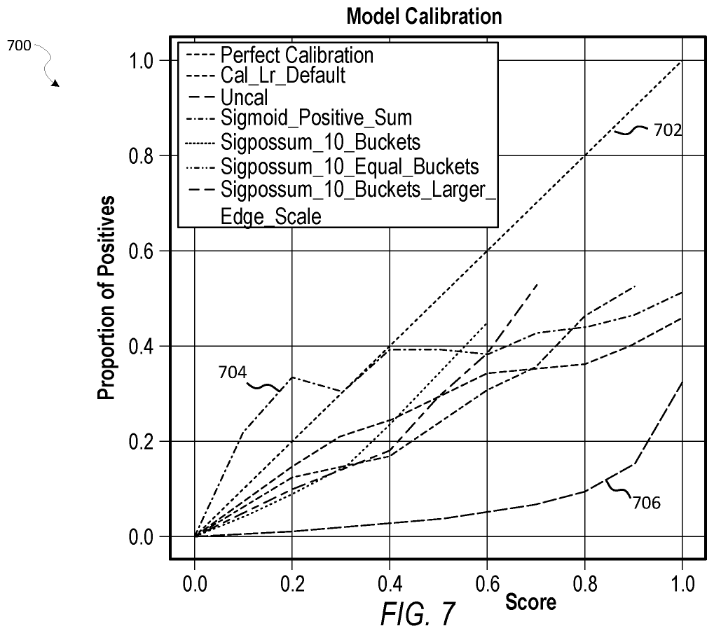

FIG. 7 is a block diagram illustrating an example chart 700 generated by a data management system, according to various embodiments of the present disclosure. As shown, Line 702 represents a line of perfectly calibrated scores where a calibrated score equals a probability of fraud that indicates the amount of fraudulent transactions in a particular set of transactions. Line 704 represents a line of calibrated scores that are generated based on the positive sum of sigmoids algorithm, as described herein. Line 706 represents a line of uncalibrated scores (or raw scores) that are outputs of uncalibrated machine learning models, as described herein.

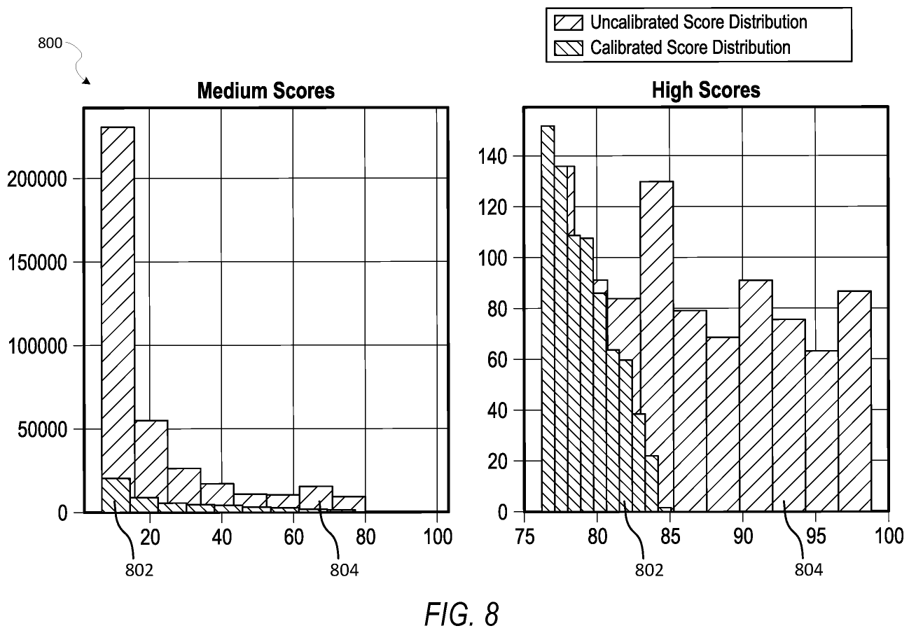

FIG. 8 is a block diagram illustrating example graphs 800 generated by a data management system before a score scaling function is used, according to various embodiments of the present disclosure. As illustrated, a significant distribution shift is shown between uncalibrated score distribution 804 (e.g., a score distribution of uncalibrated raw scores) and calibrated score distribution 802 (e.g., a score distribution of calibrated raw scores), especially in high score ranges. Calibrated raw scores refer to scores that are generated by the calibration model before applying a score scaling function described herein.

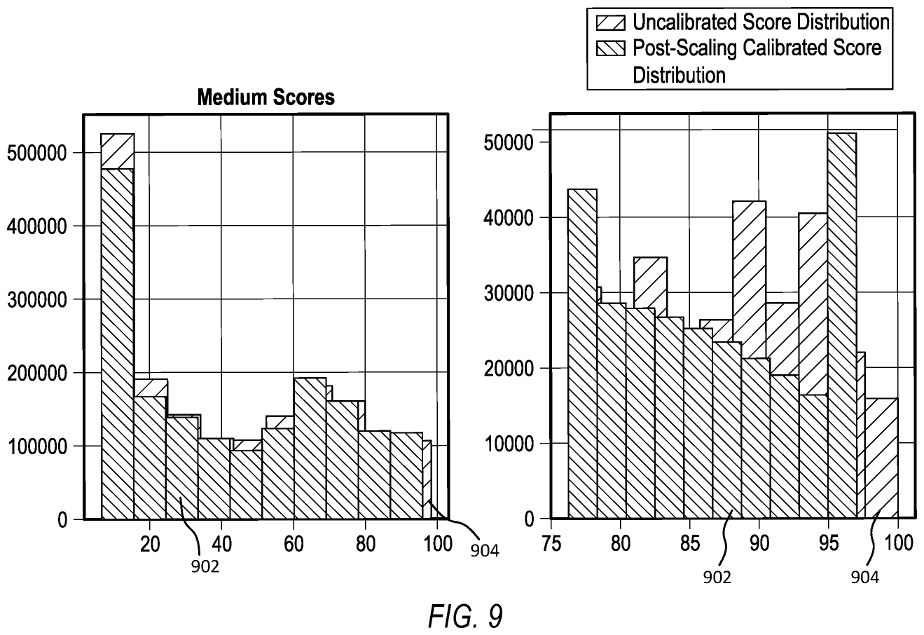

FIG. 9 is a block diagram illustrating example graphs generated by a data management system after a score scaling function is used (or applied), according to various embodiments of the present disclosure. As illustrated, after scaling, the post-scaling calibrated score distribution 904 (e.g., a score distribution of calibrated scaled scores) nearly overlaps with the uncalibrated score distribution 902 (e.g., a score distribution of uncalibrated scaled scores), thereby significantly reducing the distribution shift.

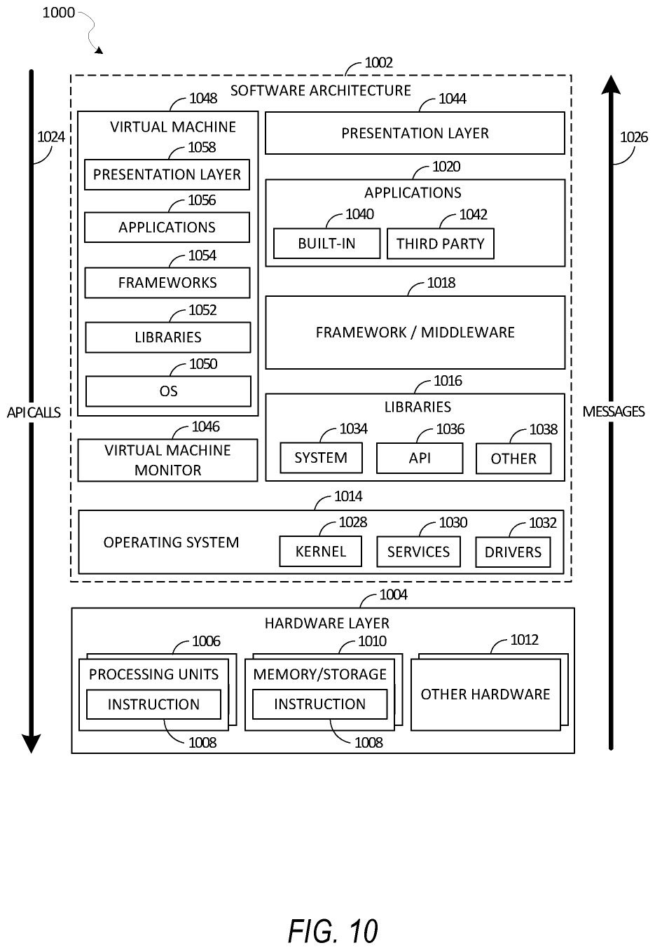

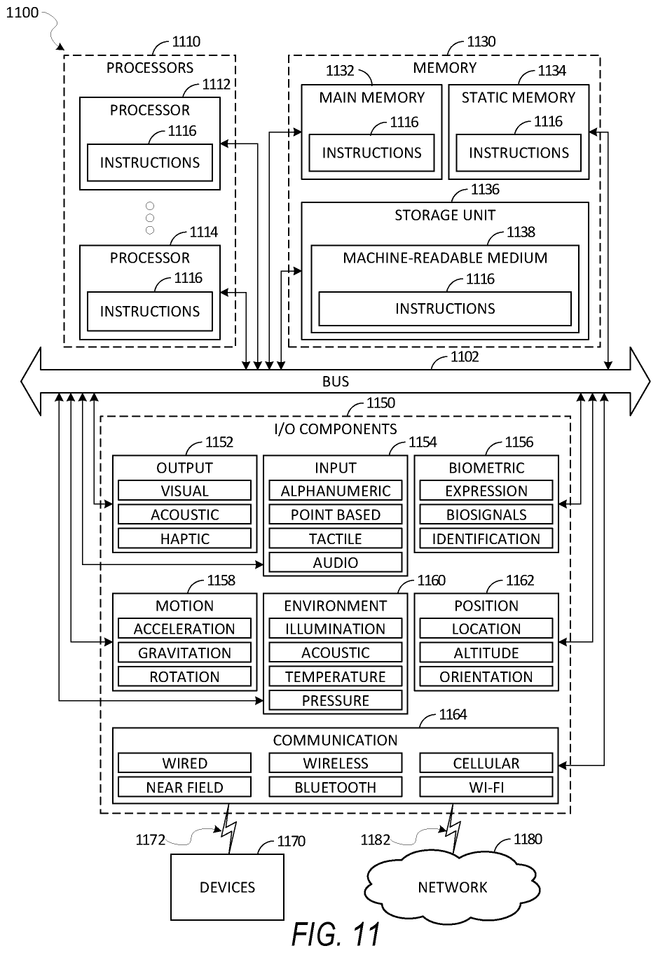

FIG. 10 is a block diagram 1000 illustrating an example of a software architecture 1002 that may be installed on a machine, according to some example embodiments. FIG. 10 is merely a non-limiting example of a software architecture, and it will be appreciated that many other architectures may be implemented to facilitate the functionality described herein. The software architecture 1002 may be executing on hardware such as a machine 1100 of FIG. 11 that includes, among other things, processors 1110, memory 1130, and input/output (I/O) components 1150. A representative hardware layer 1004 is illustrated and can represent, for example, the machine 1100 of FIG. 11. The representative hardware layer 1004 comprises one or more processing units 1006 having associated executable instructions 1008. The executable instructions 1008 represent the executable instructions of the software architecture 1002. The hardware layer 1004 also includes memory or storage modules 1010, which also have the executable instructions 1008. The hardware layer 1004 may also comprise other hardware 1012, which represents any other hardware of the hardware layer 1004, such as the other hardware illustrated as part of the machine 1200.

In the example architecture of FIG. 10, the software architecture 1002 may be conceptualized as a stack of layers, where each layer provides particular functionality. For example, the software architecture 1002 may include layers such as an operating system 1014, libraries 1016, frameworks/middleware 1018, applications 1020, and a presentation layer 1044. Operationally, the applications 1020 or other components within the layers may invoke API calls 1024 through the software stack and receive a response, returned values, and so forth (illustrated as messages 1026) in response to the API calls 1024. The layers illustrated are representative in nature, and not all software architectures have all layers. For example, some mobile or special-purpose operating systems may not provide a frameworks/middleware 1018 layer, while others may provide such a layer. Other software architectures may include additional or different layers.

The operating system 1014 may manage hardware resources and provide common services. The operating system 1014 may include, for example, a kernel 1028, services 1030, and drivers 1032. The kernel 1028 may act as an abstraction layer between the hardware and the other software layers. For example, the kernel 1028 may be responsible for memory management, processor management (e.g., scheduling), component management, networking, security settings, and so on. The services 1030 may provide other common services for the other software layers. The drivers 1032 may be responsible for controlling or interfacing with the underlying hardware. For instance, the drivers 1032 may include display drivers, camera drivers, Bluetooth ° drivers, flash memory drivers, serial communication drivers (e.g., Universal Serial Bus (USB) drivers), WiFi® drivers, audio drivers, power management drivers, and so forth depending on the hardware configuration.

The libraries 1016 may provide a common infrastructure that may be utilized by the applications 1020 and/or other components and/or layers. The libraries 1016 typically provide functionality that allows other software modules to perform tasks in an easier fashion than by interfacing directly with the underlying operating system 1014 functionality (e.g., kernel 1028, services 1030, or drivers 1032). The libraries 1016 may include system libraries 1034 (e.g., C standard library) that may provide functions such as memory allocation functions, string manipulation functions, mathematic functions, and the like. In addition, the libraries 1016 may include API libraries 1036 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 1016 may also include a wide variety of other libraries 1038 to provide many other APIs to the applications 1020 and other software components/modules.

The frameworks 1018 (also sometimes referred to as middleware) may provide a higher-level common infrastructure that may be utilized by the applications 1020 or other software components/modules. For example, the frameworks 1018 may provide various graphical user interface functions, high-level resource management, high-level location services, and so forth. The frameworks 1018 may provide a broad spectrum of other APIs that may be utilized by the applications 1020 and/or other software components/modules, some of which may be specific to a particular operating system or platform.

The applications 1020 include built-in applications 1040 and/or third-party applications 1042. Examples of representative built-in applications 1040 may include, but are not limited to, a home application, a contacts application, a browser application, a book reader application, a location application, a media application, a messaging application, or a game application.

The third-party applications 1042 may include any of the built-in applications 1040, as well as a broad assortment of other applications. In a specific example, the third-party applications 1042 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 1042 may invoke the API calls 1024 provided by the mobile operating system such as the operating system 1014 to facilitate functionality described herein.

The applications 1020 may utilize built-in operating system functions (e.g., kernel 1028, services 1030, or drivers 1032), libraries (e.g., system libraries 1034, API libraries 1036, and other libraries 1038), or frameworks/middleware 1018 to create user interfaces to interact with users of the system. Alternatively, or additionally, in some systems, interactions with a user may occur through a presentation layer, such as the presentation layer 1044. In these systems, the application/module “logic” can be separated from the aspects of the application/module that interact with the user.

Some software architectures utilize virtual machines. In the example of FIG. 10, this is illustrated by a virtual machine 1048. The virtual machine 1048 creates a software environment where applications/modules can execute as if they were executing on a hardware machine (e.g., the machine 1100 of FIG. 11). The virtual machine 1048 is hosted by a host operating system (e.g., the operating system 1014) and typically, although not always, has a virtual machine monitor 1046, which manages the operation of the virtual machine 1048 as well as the interface with the host operating system (e.g., the operating system 1014). A software architecture executes within the virtual machine 1048, such as an operating system 1050, libraries 1052, frameworks/middleware 1054, applications 1056, or a presentation layer 1058. These layers of software architecture executing within the virtual machine 1048 can be the same as corresponding layers previously described or may be different.

FIG. 11 illustrates a diagrammatic representation of a machine 1100 in the form of a computer system within which a set of instructions may be executed for causing the machine 1100 to perform any one or more of the methodologies discussed herein, according to an embodiment. Specifically, FIG. 11 shows a diagrammatic representation of the machine 1100 in the example form of a computer system, within which instructions 1116 (e.g., software, a program, an application, an applet, an app, or other executable code) for causing the machine 1100 to perform any one or more of the methodologies discussed herein may be executed. For example, the instructions 1116 may cause the machine 1100 to execute method 300 as described in FIG. 3 and method 400 as described in FIG. 4. The instructions 1116 transform the general, non-programmed machine 1100 into a particular machine 1100 programmed to carry out the described and illustrated functions in the manner described. In alternative embodiments, the machine 1100 operates as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, or any machine capable of executing the instructions 1116, sequentially or otherwise, that specify actions to be taken by the machine 1100. Further, while only a single machine 1100 is illustrated, the term “machine” shall also be taken to include a collection of machines 1100 that individually or jointly execute the instructions 1116 to perform any one or more of the methodologies discussed herein.

The machine 1100 may include processors 1110, memory 1130, and I/O components 1150, which may be configured to communicate with each other such as via a bus 1102. In an embodiment, the processors 1110 (e.g., a hardware processor, such as a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1112 and a processor 1114 that may execute the instructions 1116. The term “processor” is intended to include multi-core processors that may comprise two or more independent processors (sometimes referred to as “cores”) that may execute instructions contemporaneously. Although FIG. 11 shows multiple processors 1110, the machine 1100 may include a single processor with a single core, a single processor with multiple cores (e.g., a multi-core processor), multiple processors with a single core, multiple processors with multiples cores, or any combination thereof.

The memory 1130 may include a main memory 1132, a static memory 1134, and a storage unit 1136 including machine-readable medium 1138, each accessible to the processors 1110 such as via the bus 1102. The main memory 1132, the static memory 1134, and the storage unit 1136 store the instructions 1116 embodying any one or more of the methodologies or functions described herein. The instructions 1116 may also reside, completely or partially, within the main memory 1132, within the static memory 1134, within the storage unit 1136, within at least one of the processors 1110 (e.g., within the processor's cache memory), or any suitable combination thereof, during execution thereof by the machine 1100.

The I/O components 1150 may include a wide variety of components to receive input, provide output, produce output, transmit information, exchange information, capture measurements, and so on. The specific I/O components 1150 that are included in a particular machine will depend on the type of machine. For example, portable machines such as mobile phones will likely include a touch input device or other such input mechanisms, while a headless server machine will likely not include such a touch input device. It will be appreciated that the I/O components 1150 may include many other components that are not shown in FIG. 11. The I/O components 1150 are grouped according to functionality merely for simplifying the following discussion, and the grouping is in no way limiting. In various embodiments, the I/O components 1150 may include output components 1152 and input components 1154. The output components 1152 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1154 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further embodiments, the I/O components 1150 may include biometric components 1156, motion components 1158, environmental components 1160, or position components 1162, among a wide array of other components. The motion components 1158 may include acceleration sensor components (e.g., accelerometer), gravitation sensor components, rotation sensor components (e.g., gyroscope), and so forth. The environmental components 1160 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1162 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1150 may include communication components 1164 operable to couple the machine 1100 to a network 1180 or devices 1170 via a coupling 1182 and a coupling 1172, respectively. For example, the communication components 1164 may include a network interface component or another suitable device to interface with the network 1180. In further examples, the communication components 1164 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 1170 may be another machine or any of a wide variety of peripheral devices (e.g., a peripheral device coupled via a USB).

Moreover, the communication components 1164 may detect identifiers or include components operable to detect identifiers. For example, the communication components 1164 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1164, such as location via Internet Protocol (IP) geolocation, location via Wi-Fi® signal triangulation, location via detecting an NFC beacon signal that may indicate a particular location, and so forth.

Certain embodiments are described herein as including logic or a number of components, modules, elements, or mechanisms. Such modules can constitute either software modules (e.g., code embodied on a machine-readable medium or in a transmission signal) or hardware modules. A “hardware module” is a tangible unit capable of performing certain operations and can be configured or arranged in a certain physical manner. In various example embodiments, one or more computer systems (e.g., a standalone computer system, a client computer system, or a server computer system) or one or more hardware modules of a computer system (e.g., a processor or a group of processors) are configured by software (e.g., an application or application portion) as a hardware module that operates to perform certain operations as described herein.

In various embodiments, a hardware module is implemented mechanically, electronically, or any suitable combination thereof. For example, a hardware module can include dedicated circuitry or logic that is permanently configured to perform certain operations. For example, a hardware module can be a special-purpose processor, such as a field-programmable gate array (FPGA) or an ASIC. A hardware module may also include programmable logic or circuitry that is temporarily configured by software to perform certain operations. For example, a hardware module can include software encompassed within a general-purpose processor or other programmable processor. It will be appreciated that the decision to implement a hardware module mechanically, in dedicated and permanently configured circuitry, or in temporarily configured circuitry (e.g., configured by software) can be driven by cost and time considerations.

Accordingly, the phrase “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software can accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In embodiments in which multiple hardware modules are configured or instantiated at different times, communications between or among such hardware modules may be achieved, for example, through the storage and retrieval of information in memory structures to which the multiple hardware modules have access. For example, one hardware module performs an operation and stores the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines 1100 including processors 1110), with these operations being accessible via a network (e.g., the Internet) and via one or more appropriate interfaces (e.g., an API). In certain embodiments, for example, a client device may relay or operate in communication with cloud computing systems, and may access circuit design information in a cloud environment.

The performance of certain of the operations may be distributed among the processors, not only residing within a single machine 1100, but deployed across a number of machines 1100. In some example embodiments, the processors 1110 or processor-implemented modules are located in a single geographic location (e.g., within a home environment, an office environment, or a server farm). In other example embodiments, the processors or processor-implemented modules are distributed across a number of geographic locations.

### Executable Instructions and Machine Storage Medium

The various memories (i.e., 1130, 1132, 1134, and/or the memory of the processor(s) 1110) and/or the storage unit 1136 may store one or more sets of instructions 1116 and data structures (e.g., software) embodying or utilized by any one or more of the methodologies or functions described herein. These instructions (e.g., the instructions 1116), when executed by the processor(s) 1110, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 1116 and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various embodiments, one or more portions of the network 1180 may be an ad hoc network, an intranet, an extranet, a virtual private network (VPN), a LAN, a wireless LAN (WLAN), a WAN, a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1180 or a portion of the network 1180 may include a wireless or cellular network, and the coupling 1182 may be a Code Division Multiple Access (CDMA) connection, a Global System for Mobile communications (GSM) connection, or another type of cellular or wireless coupling. In this example, the coupling 1182 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions may be transmitted or received over the network using a transmission medium via a network interface device (e.g., a network interface component included in the communication components) and utilizing any one of a number of well-known transfer protocols (e.g., hypertext transfer protocol (HTTP)). Similarly, the instructions may be transmitted or received using a transmission medium via the coupling (e.g., a peer-to-peer coupling) to the devices 1170. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions for execution by the machine, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals. For instance, an embodiment described herein can be implemented using a non-transitory medium (e.g., a non-transitory computer-readable medium).

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense.

It will be understood that changes and modifications may be made to the disclosed embodiments without departing from the scope of the present disclosure. These and other changes or modifications are intended to be included within the scope of the present disclosure.

What is claimed is:

1. A method comprising:
identifying an uncalibrated fraud score that corresponds to a set of transactions, the uncalibrated fraud score indicating a likelihood that the set of transactions includes at least one fraudulent transaction;
using a machine learning model to generate a calibrated fraud score based on the uncalibrated fraud score, the calibrated fraud score indicating an amount of the set of transactions that are fraudulent;
determining a calibrated fraud score distribution associated with the calibrated fraud score;
identifying an uncalibrated fraud score distribution associated with the uncalibrated fraud score;
using a score scaling function to generate a mapping between the calibrated fraud score distribution and the uncalibrated fraud score distribution;
generating a scaled calibrated fraud score based on the mapping, the scaled calibrated fraud score corresponding to a percentile of the uncalibrated fraud score that appears in the uncalibrated fraud score distribution; and
causing display of the mapping and the scaled calibrated fraud score on a user interface of a device.

2. The method of claim 1, further comprising:
generating a post-scaling calibrated fraud score distribution based on the scaled calibrated fraud score.

3. The method of claim 2, further comprising:
receiving a request to adjust the post-scaling calibrated fraud score distribution, the request including one or more parameters associated with an adjusted post-scaling calibrated fraud score distribution;
using the score scaling function to generate an updated mapping based on the one or more parameters; and
causing display of the updated mapping and the adjusted post-scaling calibrated fraud score distribution on the user interface of the device.

4. The method of claim 1, wherein the calibrated fraud score distribution comprises a plurality of calibrated fraud scores, each calibrated fraud score corresponding to an amount of a corresponding set of transactions that are fraudulent.

5. The method of claim 1, further comprising:
generating the machine learning model that uses a positive sum of sigmoids algorithm to calibrate the uncalibrated fraud score based on a calibration function and training data.

6. The method of claim 5, wherein the training data comprises other calibrated fraud scores that are generated based on other uncalibrated fraud scores associated with other sets of transactions.

7. The method of claim 5, wherein the positive sum of sigmoids algorithm defines a plurality of sigmoid functions, further comprising:
using the positive sum of sigmoids algorithm to learn a calibration function that maps the uncalibrated fraud score to the calibrated fraud scores.

8. The method of claim 1, further comprising:
determining one or more weights based on the using of the machine learning model;
determining a percentage of the amount of the set of transactions that are fraudulent based on a number of the set of transactions;
evaluating a correspondence between the calibrated fraud score and the percentage;
based on the evaluating of the correspondence, updating the one or more weights to improve the correspondence between the calibrated fraud score and the percentage; and
causing the machine learning model to generate further calibrated fraud scores based on one or more updated weights.

9. The method of claim 1, wherein the machine learning model is a first machine learning model, and wherein the uncalibrated fraud score is a first uncalibrated fraud score, further comprising:
accessing a plurality of transactions associated with an entity, the plurality of transactions including the set of transactions;
using a second machine learning model to generate a plurality of uncalibrated fraud scores that includes the first uncalibrated fraud score; and
determining the uncalibrated fraud score distribution based on the plurality of uncalibrated fraud scores.

10. The method of claim 1, wherein the calibrated fraud score represents a percentage of the set of transactions that are fraudulent.

11. A system comprising:
a memory storing instructions; and
one or more hardware processors communicatively coupled to the memory and configured by the instructions to perform operations comprising:
identifying an uncalibrated fraud score that corresponds to a set of transactions, the uncalibrated fraud score indicating a likelihood that the set of transactions includes at least one fraudulent transaction;
using a machine learning model to generate a calibrated fraud score based on the uncalibrated fraud score, the calibrated fraud score indicating an amount of the set of transactions that are fraudulent;
determining a calibrated fraud score distribution associated with the calibrated fraud score;
identifying an uncalibrated fraud score distribution associated with the uncalibrated fraud score;
using a score scaling function to generate a mapping between the calibrated fraud score distribution and the uncalibrated fraud score distribution;
generating a scaled calibrated fraud score based on the mapping, the scaled calibrated fraud score corresponding to a percentile of the uncalibrated fraud score that appears in the uncalibrated fraud score distribution; and
causing display of the mapping and the scaled calibrated fraud score on a user interface of a device.

12. The system of claim 11, wherein the operations further comprise:
generating a post-scaling calibrated fraud score distribution based on the scaled calibrated fraud score.

13. The system of claim 12, wherein the operations further comprise:
receiving a request to adjust the post-scaling calibrated fraud score distribution, the request including one or more parameters associated with an adjusted post-scaling calibrated fraud score distribution;
using the score scaling function to generate an updated mapping based on the one or more parameters; and
causing display of the updated mapping and the adjusted post-scaling calibrated fraud score distribution on the user interface of the device.

14. The system of claim 11, wherein the calibrated fraud score distribution comprises a plurality of calibrated fraud scores, each calibrated fraud score corresponding to an amount of a corresponding set of transactions that are fraudulent.

15. The system of claim 11, wherein the operations further comprise:
generating the machine learning model that uses a positive sum of sigmoids algorithm to calibrate the uncalibrated fraud score based on a calibration function and training data.

16. The system of claim 15, wherein the training data comprises other calibrated fraud scores that are generated based on other uncalibrated fraud scores associated with other sets of transactions.

17. The system of claim 15, wherein the positive sum of sigmoids algorithm defines a plurality of sigmoid functions, further comprising:
using the positive sum of sigmoids algorithm to learn a calibration function that maps the uncalibrated fraud score to the calibrated fraud scores.

18. The system of claim 11, wherein the operations further comprise:
determining one or more weights based on the using of the machine learning model;
determining a percentage of the amount of the set of transactions that are fraudulent based on a number of the set of transactions;
evaluating a correspondence between the calibrated fraud score and the percentage;
based on the evaluating of the correspondence, updating the one or more weights to improve the correspondence between the calibrated fraud score and the percentage; and
causing the machine learning model to generate further calibrated fraud scores based on one or more updated weights.

19. The system of claim 11, wherein the machine learning model is a first machine learning model, and wherein the uncalibrated fraud score is a first uncalibrated fraud score, further comprising:
accessing a plurality of transactions associated with an entity, the plurality of transactions including the set of transactions;
using a second machine learning model to generate a plurality of uncalibrated fraud scores that includes the first uncalibrated fraud score; and
determining the uncalibrated fraud score distribution based on the plurality of uncalibrated fraud scores.

20. A non-transitory computer-readable medium comprising instructions that, when executed by a hardware processor of a device, cause the device to perform operations comprising:
identifying an uncalibrated fraud score that corresponds to a set of transactions, the uncalibrated fraud score indicating a likelihood that the set of transactions includes at least one fraudulent transaction;
using a machine learning model to generate a calibrated fraud score based on the uncalibrated fraud score, the calibrated fraud score indicating an amount of the set of transactions that are fraudulent;
determining a calibrated fraud score distribution associated with the calibrated fraud score;
identifying an uncalibrated fraud score distribution associated with the uncalibrated fraud score;
using a score scaling function to generate a mapping between the calibrated fraud score distribution and the uncalibrated fraud score distribution;
generating a scaled calibrated fraud score based on the mapping, the scaled calibrated fraud score corresponding to a percentile of the uncalibrated fraud score that appears in the uncalibrated fraud score distribution; and
causing display of the mapping and the scaled calibrated fraud score on a user interface of a device.
